(19) United States
(12) Patent Application Publication
(10) Pub. No.: US 2014/0029251 A1
(43) Pub. Date: Jan. 30, 2014

(54) LED SPOTLIGHT

(71) Applicants: SUNNY GENERAL INTERNATIONAL CO., LTD., New Taipei City (TW); YUEN SHING INT'L CO., LTD., Taoyuan Hsien (TW)

(72) Inventors: CHIEN-LUNG CHANG, NEW TAIPEI CITY (TW); HUNG-YAO HSIEH, New Taipei City (TW); WEN-TE KUO, Keelung City (TW); CHUANG-YU CHIU, Taoyuan County (TW)

(73) Assignees: YUEN SHING INT'L CO., LTD., Taoyuan Hsien (TW); SUNNY GENERAL INTERNATIONAL CO., LTD., New Taipei City (TW)

(21) Appl. No.: 13/887,159

(22) Filed: May 3, 2013

(30) Foreign Application Priority Data
Jul. 24, 2012 (TW) 101214272
Dec. 25, 2012 (TW) 101149762

(51) Int. Cl. F21V 1/00

(52) U.S. Cl. CPC F21V 1/00
USPC 362/231

(57) ABSTRACT

An LED spotlight includes a base and lampshade. The base includes a power connecting portion, a heat dissipating portion and circuit board which are connected to the power connecting portion; and an LED unit disposed at the circuit board for emitting first and second light. The center-to-edge distance of the circuit board is defined as a first distance. The LED unit is separated from the center of the circuit board by a second distance. The second distance equals at least 1/10 of the first distance. The lampshade includes an opaque pipe and convex lens. The pipe has one end connected to the heat dissipating portion and the other end connected to the convex lens. The first light penetrates the convex lens to form a first light-emitting area. The second light reflects off the inner wall of the pipe and penetrates the convex lens to form a second light-emitting area.

### CROSS-REFERENCE TO RELATED APPLICATION

This non-provisional application claims priority under 35 U.S.C. §119(a) on Patent Application No(s). 101214272 filed in Taiwan, R.O.C. on Jul. 24, 2012, and Patent Application No(s). 101149762 filed in Taiwan, R.O.C. on Dec. 25, 2012, the entire contents of which are hereby incorporated by reference.

### FIELD OF THE INVENTION

The present invention relates to LED lamps, and more particularly, to an LED spotlight capable of decorative lighting.

### BACKGROUND OF THE INVENTION

A conventional LED lamp usually has a cap, a heat dissipating portion, a light emitting portion, and a non-optically functioning lampshade or an optically functioning conical light condensing cup, and is usually for use in a household, a workplace, or a public space. However, the application of the conventional LED lamp is restricted to illumination-related purposes.

Although the light emitting portion of the conventional LED lamp comes in different colors and emitted light rays in a wide variety of ways characterized by specific lighting changes and specific flashes. However, the prior art has a drawback, that is, the light rays are always straights but lack any unique irradiative shape.

Accordingly, it is imperative to provide an LED spotlight for use in decorative lighting and generating a unique irradiative shape so as to be applicable to a night lamp, an esthetical lamp, a mood lamp, or a column lamp.

### SUMMARY OF THE INVENTION

It is an objective of the present invention to provide an LED spotlight for emitting a light ray that assumes a special shape for use in decorative lighting.

Another objective of the present invention is to provide an LED spotlight for imitating the optical and imaging effects of polar auroras such that watchers thereof can enjoy watching the optical and imaging effects of the polar auroras without visiting a polar region.

In order to achieve the above and other objectives, the present invention provides an LED spotlight comprising a base and a lampshade.

The base comprises: a power connecting portion; a heat dissipating portion connected to the power connecting portion; a circuit board electrically connected to the power connecting portion, wherein a distance between a center of the circuit board and an edge of the circuit board is defined as a first distance; and at least an LED unit disposed at the circuit board, wherein a distance between the LED unit and the center of the circuit board is defined as a second distance, the second distance being at least 1/10 of the first distance, and the LED unit has at least an LED chip for emitting a first light and a second light.

The lampshade comprises: an opaque pipe having a first end and a second end, the first end having an engagement portion, and the second end being connected to the heat dissipating portion; and a convex lens disposed at the engagement portion.

The first light passes through the convex lens to form a first light-emitting area, and the second light reflects off an inner wall of the opaque pipe before passing through the convex lens to form a second light-emitting area.

In an embodiment of the present invention, in the situation where the second distance approximates 1/10 of the first distance, the second light-emitting area is crescent-shaped. In the situation where the second distance approximates ½ of the first distance, the second light-emitting area is bar-shaped. In the situation where the second distance approximates the first distance, the second light-emitting area resembles two connected crescents in shape, and the crescents are aligned lengthwise.

In an embodiment of the present invention, the inner wall of the opaque pipe is treated by polishing, engravement, or casting. The inner wall of the opaque pipe is marked with straight lines or sloping lines.

In an embodiment of the present invention, the LED unit and the circuit board have an included angle therebetween, and the first light emitted from the LED chips propagates in a direction away from the center of the circuit board. The included angle ranges from 10° to 80°.

In an embodiment of the present invention, the LED unit is geometrically shaped. The LED unit is round or heart-shaped.

In an embodiment of the present invention, the convex lens is of a focal length 1 f, and the convex lens is spaced apart from the LED unit by a distance equal to 0.2 f to 1 f.

In an embodiment of the present invention, the LED chips include yellow chips, white chips, red chips, green chips, or blue chips.

In an embodiment of the present invention, the LED unit has three LED chips, whereas the LED chips are, namely a red chip, a green chip and a blue chip, respectively.

In an embodiment of the present invention, in the situation where the base has a plurality of LED units, the base further comprises a controller. The controller is electrically connected to the circuit board to thereby control the duration of light emission, brightness of light emitted, and a combination thereof of LED chips of the LED units.

In an embodiment of the present invention, in the situation where the LED unit has a plurality of LED chips, the base further comprises a controller. The controller is electrically connected to the circuit board to thereby control the duration of light emission, brightness of light emitted and a combination thereof of the LED chips.

In an embodiment of the present invention, the base has five LED units. In an embodiment of the present invention, the opaque pipe is made of a heat dissipating material. The opaque pipe is made of a metal or a highly thermally conductive plastic.

In conclusion, the present invention provides an LED spotlight characterized in that: not only does light emitted therefrom take on a special shape according to the configuration-related relationship between an LED unit and the center of a circuit board, but, with treatment, such as polishing, engravement, or casting, having been performed on the inner wall of the opaque pipe, the emitted light imitates the optical and imaging effects of polar auroras.

### BRIEF DESCRIPTION OF THE DRAWINGS

Objectives, features, and advantages of the present invention are hereunder illustrated with specific embodiments in conjunction with the accompanying drawings, in which:

FIG. 1 shows schematic views of an LED spotlight according to the present invention;

FIG. 2A is a schematic view of the position of an LED unit relative to the center of a circuit board according to the first embodiment of the present invention;

FIG. 2B is a schematic view of a first light-emitting area and a second light-emitting area of an illuminated surface according to the first embodiment of the present invention;

FIG. 3A is a schematic view of the position of the LED unit relative to the center of the circuit board according to the second embodiment of the present invention;

FIG. 3B is a schematic view of the first light-emitting area and the second light-emitting area of an illuminated surface according to the second embodiment of the present invention;

FIG. 4A is a schematic view of the position of the LED unit relative to the center of the circuit board according to the third embodiment of the present invention;

FIG. 4B is a schematic view of the first light-emitting area and the second light-emitting area of an illuminated surface according to the third embodiment of the present invention;

FIG. 5A is a schematic view of five LED units positioned proximate to the edge of the circuit board;

FIG. 5B is a schematic view of the first light-emitting area and the second light-emitting area when an illuminated surface is illuminated with the LED spotlight of FIG. 5A;

FIG. 6A is a schematic view of three LED units positioned between the center and the edge of the circuit board;

FIG. 6B is a schematic view of the first light-emitting area and the second light-emitting area when an illuminated surface is illuminated with the LED spotlight of FIG. 6A;

FIG. 7A is a schematic view of five LED units disposed at the circuit board;

FIG. 7B is a schematic view of the first light-emitting area and the second light-emitting area when an illuminated surface is illuminated with the LED spotlight of FIG. 7A;

FIG. 8A is a schematic view of the second light-emitting area of an illuminated surface when the inner wall of the opaque pipe is marked with straight lines;

FIG. 8B is a schematic view of the second light-emitting area of an illuminated surface when the inner wall of the opaque pipe is marked with sloping lines;

FIG. 9 is a schematic view of the LED unit and the circuit board which have an included angle therebetween;

FIG. 10A is a schematic view of the appearance of the LED unit;

FIG. 10B is a schematic view of the first light-emitting area and the second light-emitting area when an illuminated surface is illuminated with the LED spotlight of FIG. 10A;

FIG. 11A is a schematic view of three LED units having three LED chips, respectively;

FIG. 11B is a schematic view of the first light-emitting area and the second light-emitting area when an illuminated surface is illuminated with the LED spotlight of FIG. 11A;

FIG. 12A through FIG. 12C are schematic views of the LED spotlight with a controller according to various embodiments of the present invention;

FIG. 13A is a schematic view of the LED unit shown in FIG. 12A and mounted on the circuit board;

FIG. 13B is a schematic view of the first light-emitting area and the second light-emitting area when an illuminated surface is illuminated with the LED spotlight of FIG. 13A;

FIG. 14A is a schematic view of the LED unit shown in FIG. 12B and mounted on the circuit board; and

FIG. 14B is a schematic view of the first light-emitting area and the second light-emitting area when an illuminated surface is illuminated with the LED spotlight of FIG. 14A.

### DETAILED DESCRIPTION OF THE PREFERRED EMBODIMENTS

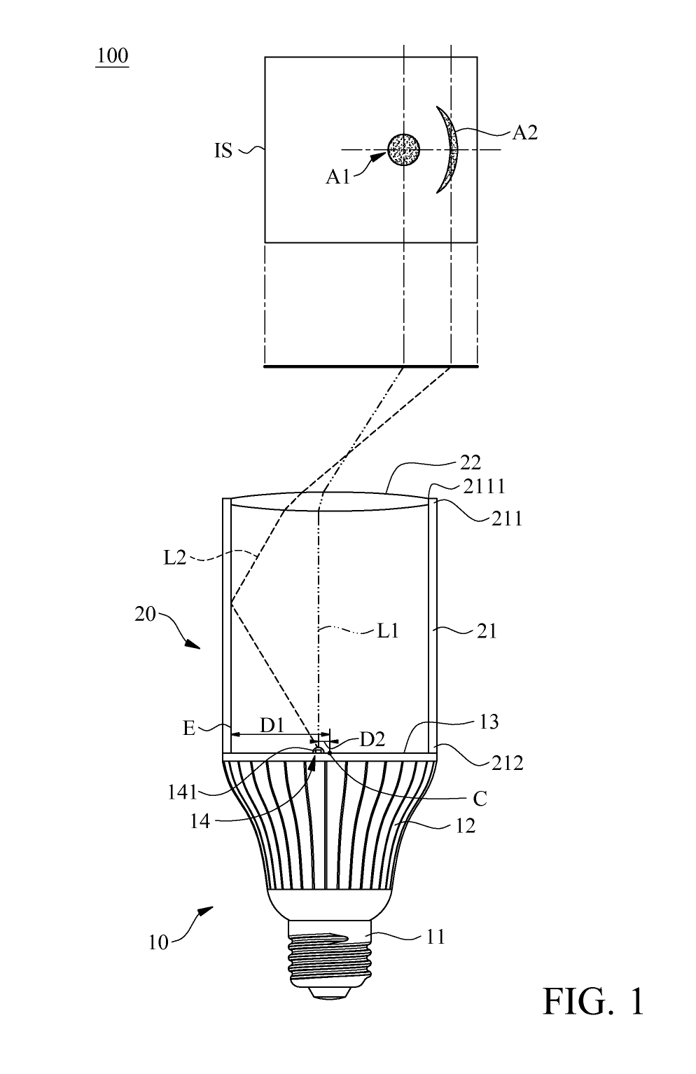

Referring to FIG. 1, there is shown a schematic view of an LED spotlight 100 according to the present invention. The LED spotlight 100 comprises a base 10 and a lampshade 20.

The base 10 comprises a power connecting portion 11, a heat dissipating portion 12, a circuit board 13, and at least an LED unit 14. The heat dissipating portion 12 is connected to the power connecting portion 11. The circuit board 13 is electrically connected to the power connecting portion 11. The distance between a center C of the circuit board 13 and an edge E of the circuit board 13 is defined as a first distance D1. The at least an LED unit 14 is mounted on the surface of the circuit board 13. The at least an LED unit 14 is electrically connected to the circuit board 13. The distance between the at least an LED unit 14 and the center C of the circuit board 13 is defined as a second distance D2. The second distance D2 equals at least 1/10 of the first distance D1. The at least an LED unit 14 has at least an LED chip 141 for emitting a first light L1 and a second light L2. The first light L1 emits light from a small angle of emission. The second light L2 emits light from a large angle of emission. The LED chips 141 include yellow chips, white chips, red chip, green chip, and blue chip. Furthermore, in the situation where the at least an LED unit 14 has three LED chips 141, the LED chips 141 are, namely a red chip, a green chip, and a blue chip, respectively. In the situation where the at least an LED unit 14 has four LED chips 141, the LED chips 141 are, namely a yellow chip, a red chip, a green chip, and a blue chip, respectively.

The lampshade 20 comprises an opaque pipe 21 and a convex lens 22. The opaque pipe 21 has a first end 211 and a second end 212. The first end has an engagement portion 2111. The second end 212 is connected to the heat dissipating portion 12. The convex lens 22 is disposed at the engagement portion 2111 by a means of engagement, snap-engagement, or fastening. The opaque pipe 21 is made of a heat dissipating material, such as a metal or a highly thermally conductive plastic, thereby speeding up the heat dissipation process of the LED spotlight.

The principle of operation of the LED spotlight 100 is described below. The first light L1 passes through the convex lens 22 to thereby form a first light-emitting area A1 on an illuminated surface IS (such as the surface of a wall, ceiling, or floor.) The second light L2 reflects off the inner wall of the opaque pipe 21 and then passes through the convex lens 22 to thereby form a second light-emitting area A2 on the illuminated surface IS. In the situation where the convex lens 22 has a focal length 1 f, the distance between the convex lens 22 and the at least an LED unit 14 is preferably 0.2 f to 1 f.

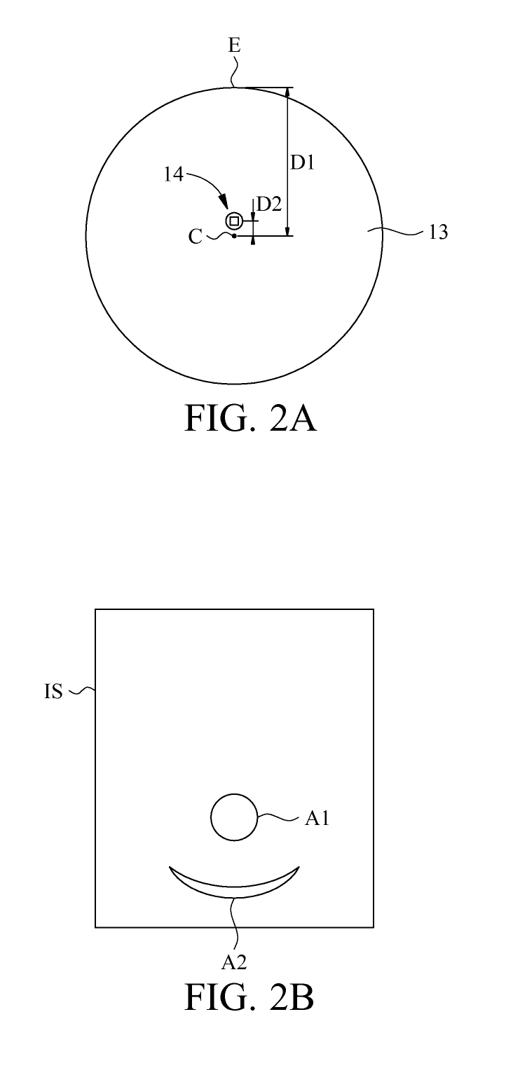

Referring to FIG. 2A through FIG. 4B, there are shown schematic views of various light-emitting areas on the illuminated surface IS in accordance with the distance between the center C and the at least an LED unit 14, respectively.

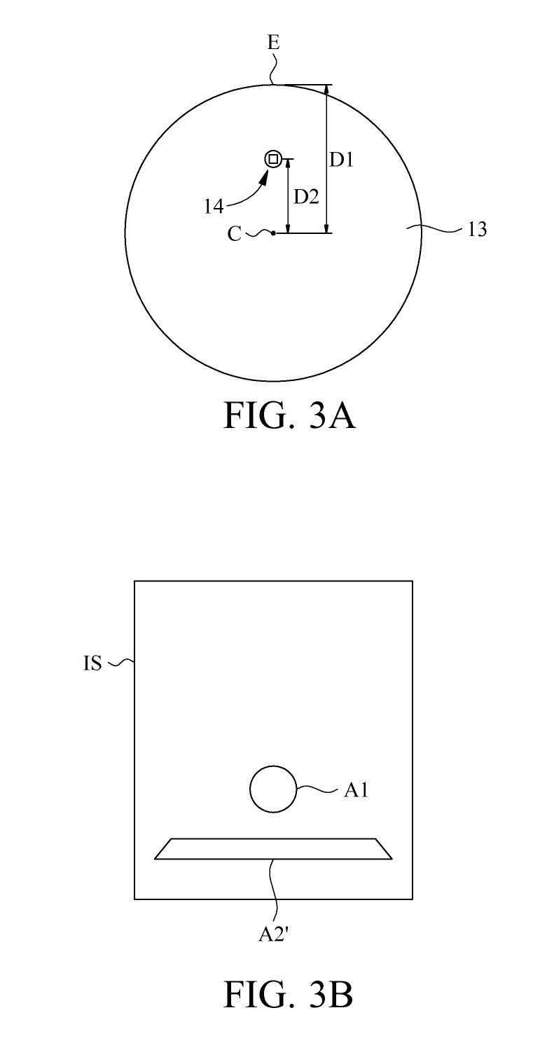

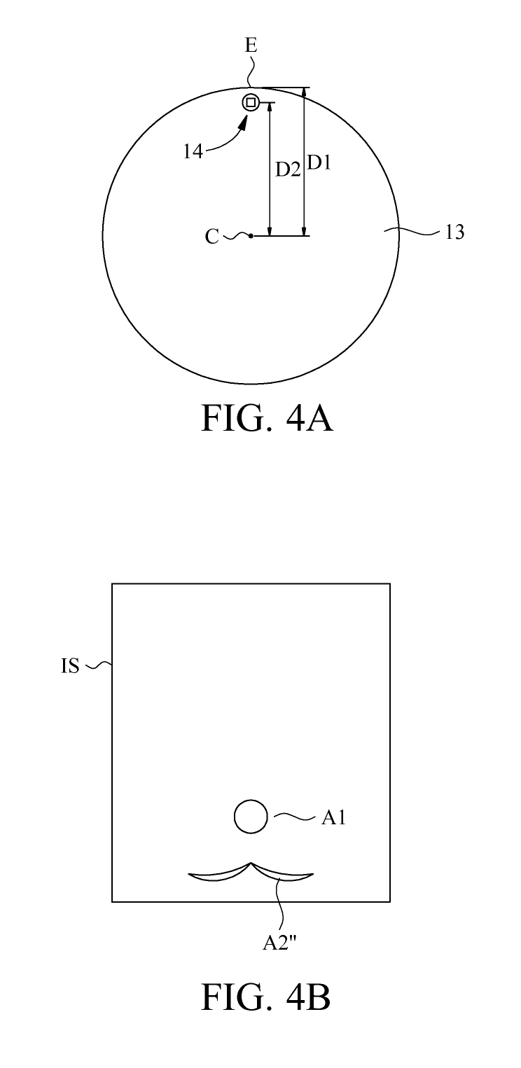

Referring to FIG. 2A and FIG. 2B, in the situation where the second distance D2 approximates 1/10 of the first distance D1, the second light-emitting area A2 is crescent-shaped. Referring to FIG. 3A and FIG. 3B, in the situation where the second distance D2 approximates ½ of the first distance D1, the second light-emitting area A2′ is bar-shaped. Referring to FIG. 4A and FIG. 4B, in the situation where the second distance D2 approximates the first distance D1, the second light-emitting area A2″ resembles two connected crescents in shape, wherein the crescents are aligned lengthwise. However, the above-mentioned merely serve to illustrate the relationship of the second distance D2 and the first distance D1, as it is also feasible for the second distance D2 and the first distance D1 to be in the other proportions in other embodiments of the present invention.

In conclusion, the at least an LED unit 14 can be positioned at a variable location on the circuit board 13 to enable the light emitted from the LED spotlight 100 to take on various shapes and thereby apply to a night lamp, an esthetical lamp, a mood lamp, or a column lamp. Furthermore, the colors of the LED chips 141 are subject to changes as needed.

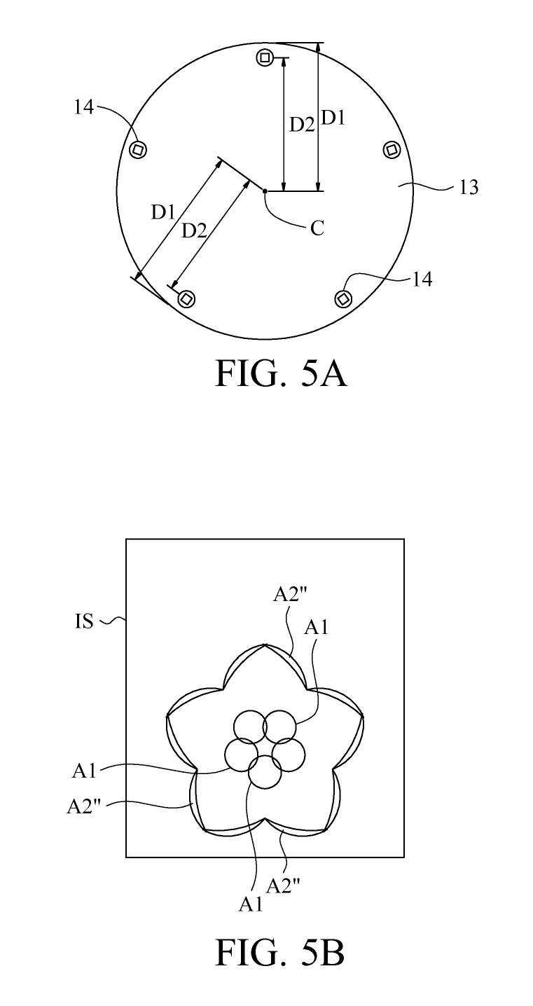

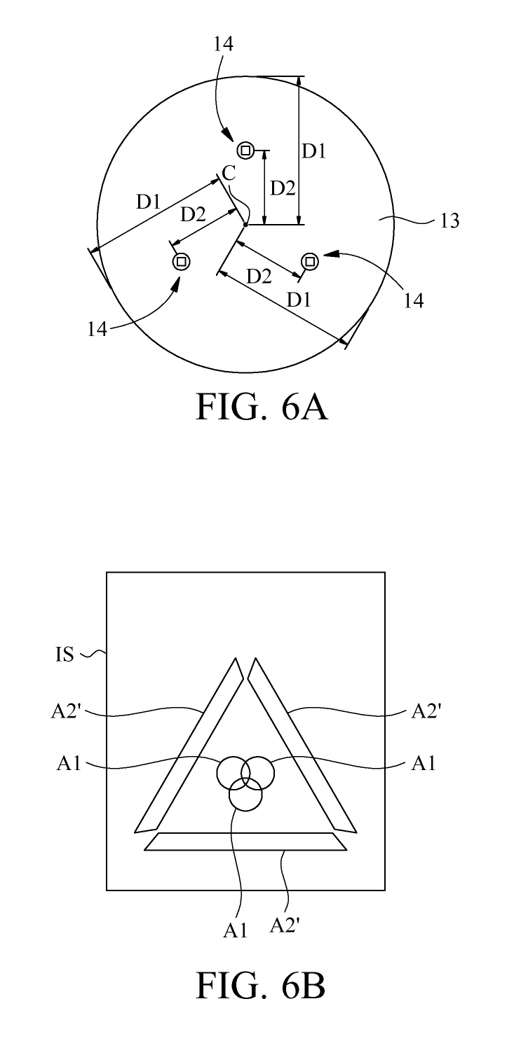

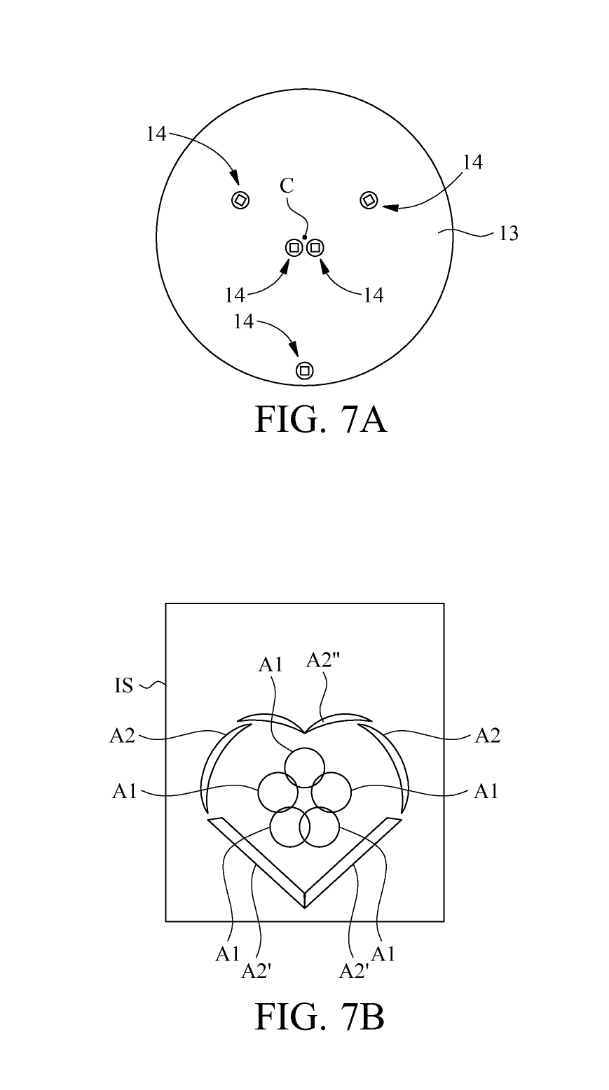

Embodiments of the LED spotlight 100 are hereunder described in conjunction with the accompanying drawings. Referring to FIG. 5A and FIG. 5B, five said LED units 14 are mounted on the circuit board 13 and, in the situation where the second distance D2 between the center C and each of the LED units 14 approximates the first distance D1, a flower-like pattern is formed within the second light-emitting areas A2″ of the illuminated surface IS. Referring to FIG. 6A and FIG. 6B, three said LED units 14 are mounted on the circuit board 13 and, in the situation where the second distance D2 between the center C and each of the LED units 14 equals ½ of the first distance D1, a triangular pattern is formed within the second light-emitting areas A2′ of the illuminated surface IS. Referring to FIG. 7A and FIG. 7B, the five LED units 14 are mounted on the circuit board 13, wherein the second distance D2 between the center C and each of two of the LED units 14 equals ½ of the first distance D1, whereas the second distance D2 between the center C and each of the other two of the LED units 14 equals 1/10 the first distance D1, and finally the second distance D2 between the center C and the last one of the LED units 14 approximates the first distance D1; in so doing, a heart-shaped pattern is formed within the second light-emitting areas A2, A2′, A2″ of the illuminated surface IS.

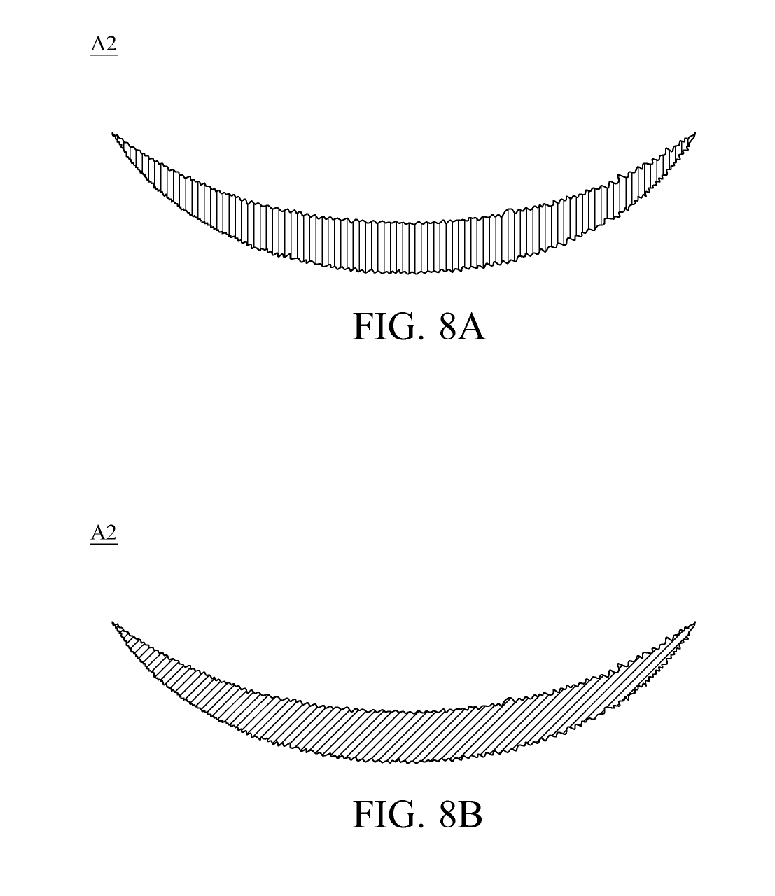

Referring to FIG. 1, FIG. 8A and FIG. 8B, the inner wall of the opaque pipe 22 has been subjected to treatment, such as polishing, engravement, or casting, and thus the inner wall of the opaque pipe 22 is marked with straight lines or sloping lines (not shown). In the situation where the inner wall of the opaque pipe 22 is marked with straight lines, the second light L2 reflects off the inner wall of the opaque pipe 22 and then passes through the convex lens 22, such that the second light-emitting area A2 formed on the illuminated surface IS carries a sense of wavy straight lines. Referring to FIG. 8A, it is therefore feasible to imitate the optical and imaging effects of polar auroras. In the situation where the inner wall of the opaque pipe 22 is marked with sloping lines, the second light L2 reflects off the inner wall of the opaque pipe 22 and then passes through the convex lens 22, such that the second light-emitting area A2 formed on the illuminated surface IS carries a sense of wavy sloping lines. Referring to FIG. 8B, it is therefore feasible to imitate the optical and imaging effects of polar auroras. In conclusion, given the aforesaid design, the LED spotlight of the present invention imitates the optical and imaging effects of polar auroras and thus is applicable to a night lamp, an esthetical lamp, a mood lamp, or a column lamp.

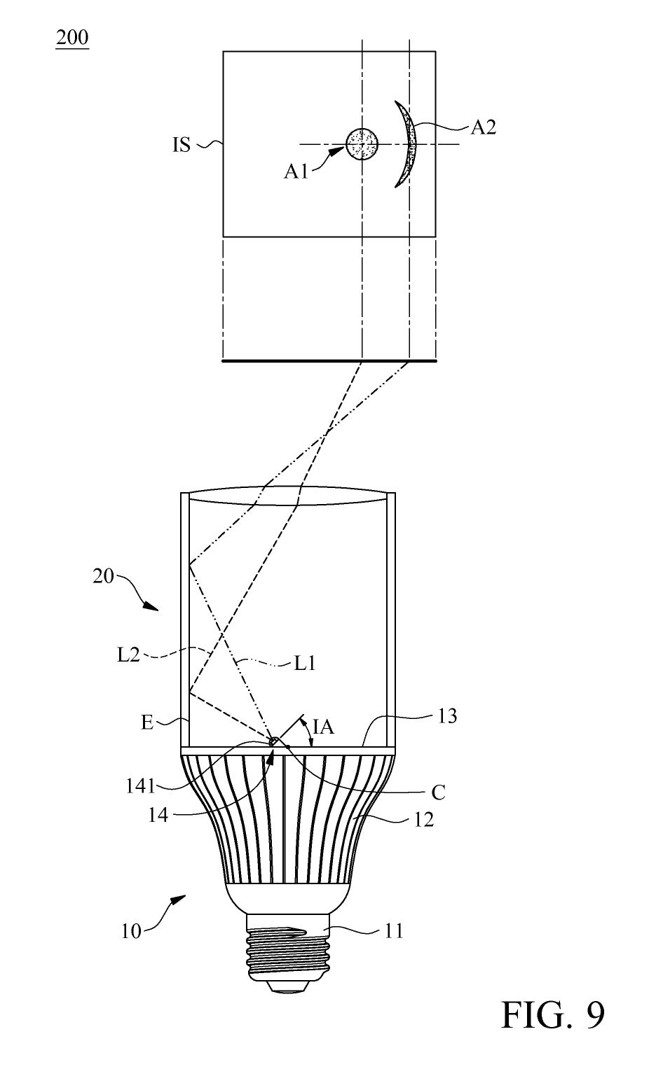

Referring to FIG. 9, an LED spotlight 200 is substantially identical to the LED spotlight 100, except the following. The at least an LED unit 14 and the circuit board 13 have an included angle IA therebetween. The first light L1 emitted from the LED chips 14 propagates in the direction away from the center C of the circuit board 13. The included angle IA ranges from 10° to 80°. The larger the included angle IA is, the dimmer is the first light L1 that falls on the first light-emitting area A1 of the illuminated surface IS, and thus the first light-emitting area A1 becomes so inconspicuous that users' attention is restricted to whatever pattern displayed within the second light-emitting area A2 on the illuminated surface IS.

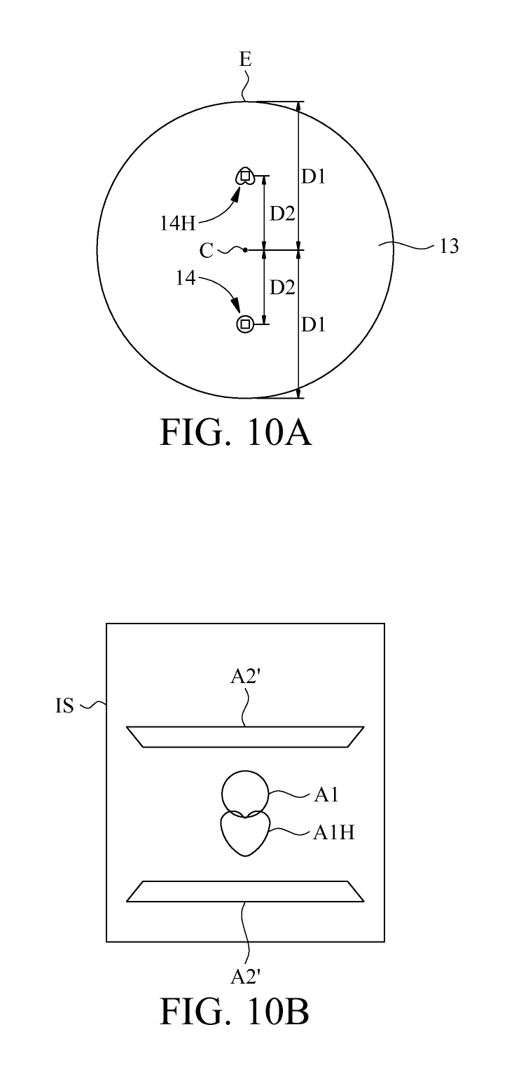

Referring to FIG. 10A and FIG. 10B, the appearance (that is, plastic package) of the LED units come in different geometrical shapes, including round, rectangular, triangular, star-shaped, heart-shaped, and polygonal. Referring to FIG. 10A, mounted on the circuit board 13 are a round LED unit 14 and a heart-shaped LED unit 14 H. The second distance D2 between the center C and each of the LED units 14, 14H equals ½ of the first distance D1. Hence, a round first light-emitting area A1, a heart-shaped first light-emitting area A1H, and a bar-shaped second light-emitting area A2′ are formed on the illuminated surface IS. It is also feasible that the five LED units 14 shown in FIG. 7A of the present invention take on another shape, say, a heart-like shape (not shown), such that both the first light-emitting area and the second light-emitting area display heart-shaped patterns.

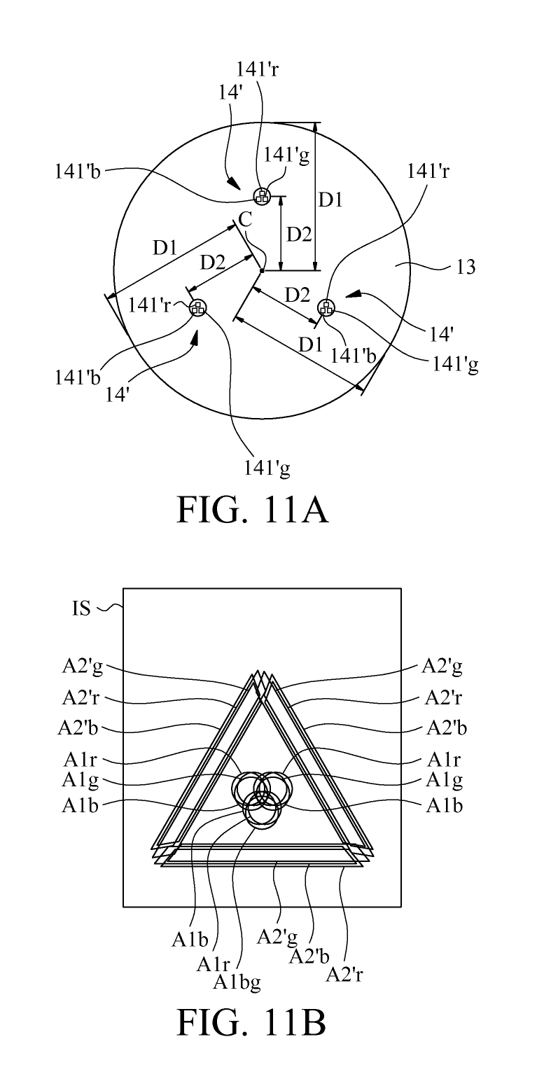

Referring to FIG. 11A and FIG. 11B, amounted on the circuit board 13 are three LED units 14′ each having has three LED chips. The LED chips are, namely a red chip 141′r, a green chip 141′g, and a blue chip 141′b, respectively. The second distance D2 between the center C and each of the LED units 14′ equals ½ of the first distance D1. Referring to FIG. 11B, hence, in the situation where each of the LED chips of the LED units 14′ forms a light-emitting area on the illuminated surface IS, there is a unique combination of color and shape of three red first light-emitting areas A1r, three green first light-emitting areas A1g, three blue first light-emitting areas A1b, three red second light-emitting areas A2′r, three green second light-emitting areas A2′g, and three blue light-emitting areas A2′b. In the situation where the inner wall of the opaque pipe of the LED spotlight is marked with straight lines (not shown), the light emitted from the second light-emitting area of the LED spotlight approximates polar auroras such that watchers thereof can enjoy watching the optical and imaging effects of the polar auroras without visiting a polar region.

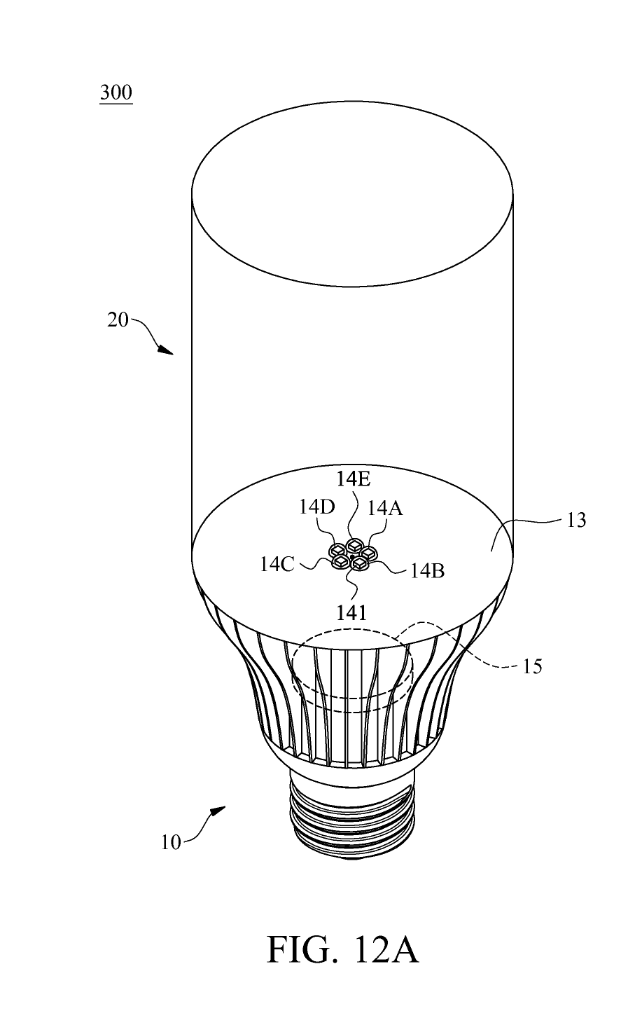

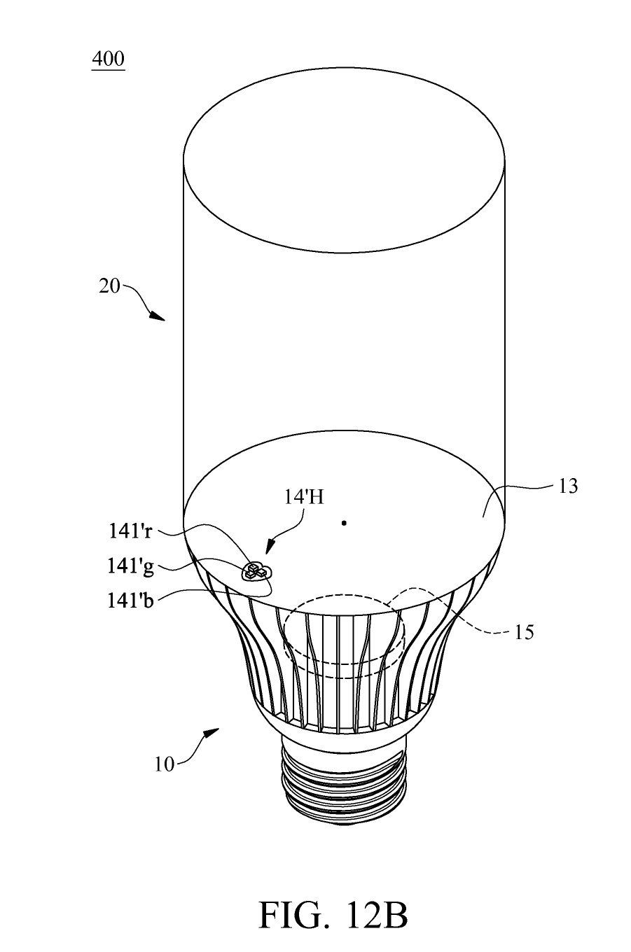

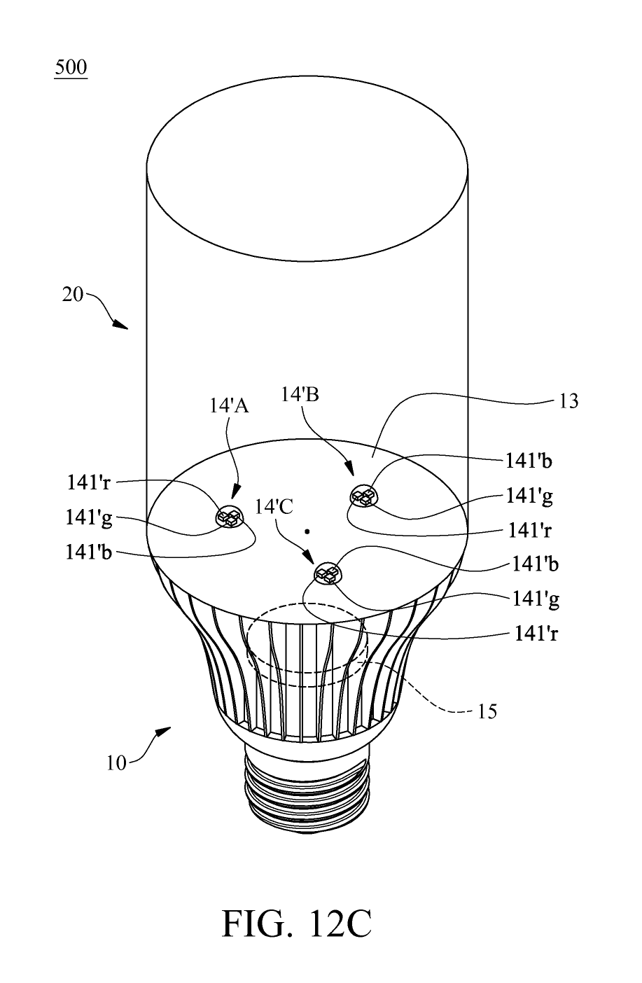

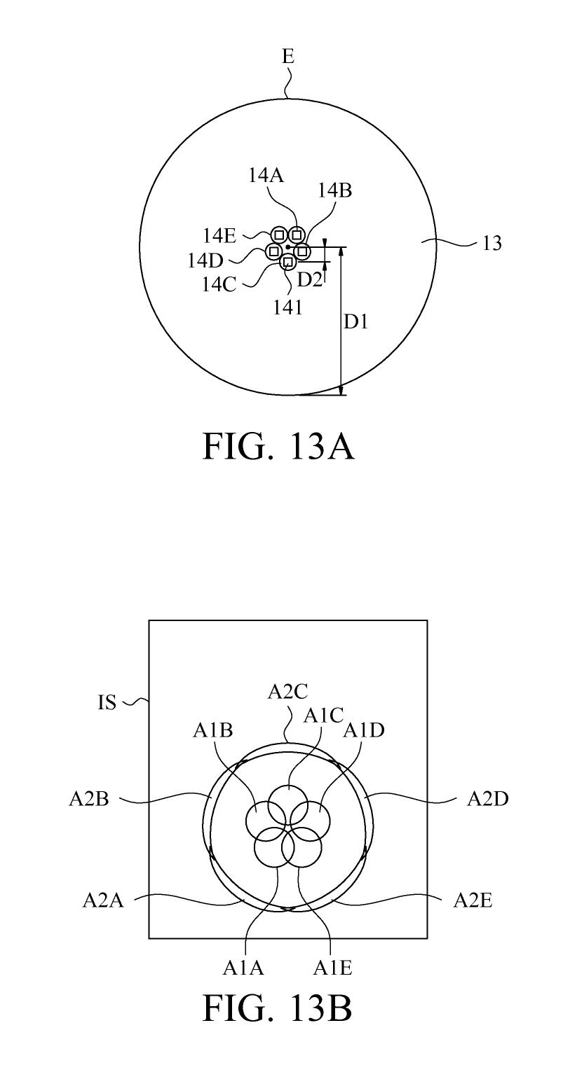

Referring to FIG. 12A and FIG. 13A, the base 10 of an LED spotlight 300 has first LED units 14A through fifth LED units 14E, which are disposed at the circuit board 13. The base 10 further comprises a controller 15. The controller 15 is electrically connected to the circuit board 13 to thereby control the duration of light emission, brightness of light emitted and a combination thereof of the LED chips 141 of the first LED units 14A through the fifth LED units 14E. Specifically speaking, the controller 15 is controlled by a controlling module and a driving module. For example, the controller 15 not only enables the first LED units 14A through the fifth LED units 14E to light up and turn off simultaneously, but also enables the first LED units 14A through the fifth LED units 14E to light up separately. In so doing, variations of light and shape occur to the first light-emitting area and the second light-emitting area formed on the illuminated surface IS. Referring to FIG. 13B and Table 1, the controller 15 has three circuits, namely circuit No. 1, circuit No. 2, and circuit No. 3. In the situation where only circuit No. 1 is enabled, the first LED units 14A through the fifth LED units 14E light up simultaneously; hence, five first light-emitting areas A1A, A1B, A1C, A1D, A1E and five second light-emitting areas A2A, A2B, A2C, A2D, A2E are present on the illuminated surface IS to thereby display a round pattern thereon. In the situation where only circuit No. 2 is enabled, only the first LED units 14A, the third LED units 14C and the fifth LED units 14E light up simultaneously; hence, three first light-emitting areas A1A, A1C, A1E and three second light-emitting areas A2A, A2C, A2E are present on the illuminated surface IS. In the situation where only circuit No. 3 is enabled, only the second LED units 14B and the fourth LED units 14D light up simultaneously; hence, only two first light-emitting areas A1B, AM and two second light-emitting areas A2B, A2D are present on the illuminated surface IS. Given the aforesaid design, the LED spotlight of the present invention is capable of altering lighting and the shape thereof and thus is applicable to a night lamp, an esthetical lamp, a mood lamp, or a column lamp.

TABLE 1

| | first LED | second LED | third LED | fourth LED | fifth LED |
|---|---|---|---|---|---|
| circuit | units 14A | units 14B | units 14C | units 14D | units 14E |
| No. 1 | lights up | lights up | lights up | lights up | lights up |
| No. 2 | lights up | turns off | lights up | turns off | lights up |
| No. 3 | turns off | lights up | turns off | lights up | turns off |

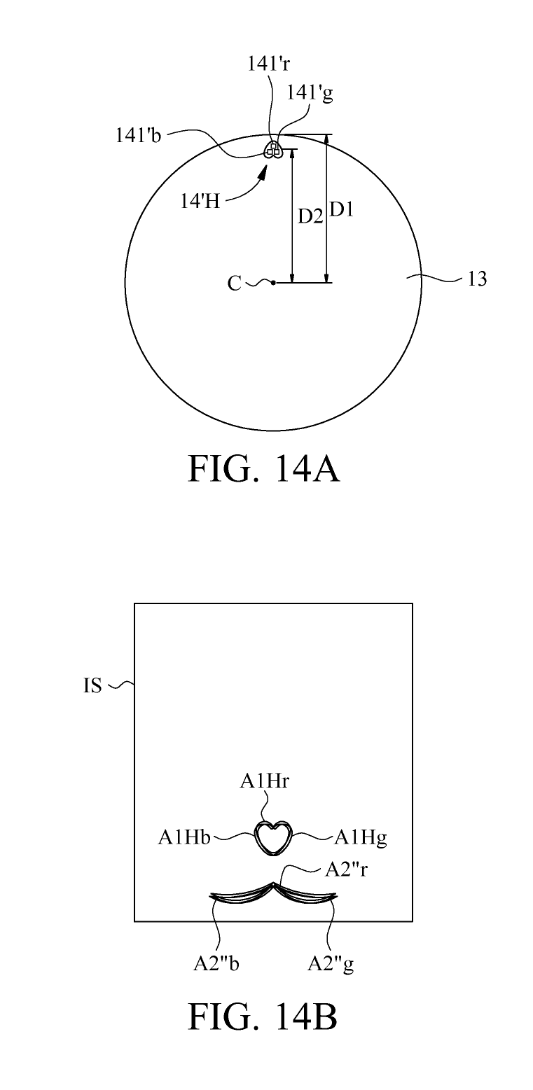

Referring to FIG. 12B and FIG. 14A, LED units 14′H of an LED spotlight 400 are heart-shaped. The LED units 14′H each have three LED chips, namely the red chip 141′r, the green chip 141′g, and the blue chip 141′b, respectively. The base 10 further comprises a controller 15. The controller 15 is electrically connected to the circuit board 13 to thereby control the duration of light emission of each of the LED chips of the LED units 14′H. For example, the controller 15 not only enables red chip 141′r, green chip 141′g, and blue chip 141′b of the LED units 14′H to light up and turn off simultaneously, but also enables red chip 141′r, green chip 141′g, and blue chip 141′b of the LED units 14′H to light up or turn off separately. Due to the aforesaid design, variations of light and shape can occur to the light emitted from the first light-emitting area and the second light-emitting area on the illuminated surface IS. Referring to FIG. 14B and Table 2, the controller 15 has three circuits, namely circuit No. 1a, circuit No. 2a, and circuit No. 3a. In the situation where only circuit 1a is enabled, red chip 141′r, green chip 141′g, and blue chip 141′b of the LED units 14′H light up simultaneously; hence, three first light-emitting areas A1Hr, A1Hg, A1Hb and three second light-emitting areas A2″r, A2″g, A2″b are present on the illuminated surface IS. In the situation where only circuit No. 2a is enabled, only red chip 141′r and blue chip 141′b of the LED units 14′H light up simultaneously; hence, two first light-emitting areas A1Hr, A1Hb and two second light-emitting areas A2″r, A2″b are present on the illuminated surface IS. In the situation only circuit No. 3a is enabled, only green chip 141′g of the LED units 14′H lights up; hence, only the first light-emitting area A1Hg and the second light-emitting area A2″g are present on the illuminated surface IS. Due to the aforesaid design, light variations are achieved

TABLE 2

| | red | | |
|---|---|---|---|
| circuit | chip 141′r | green chip 141′g | blue chip 141′b |
| No. 1a | lights up | lights up | lights up |
| No. 2a | lights up | turns off | lights up |
| No. 3a | turns off | lights up | turns off |

Referring to FIG. 12C and Table 3, an LED spotlight 500 has first LED units 14′A through third LED units 14′C. The first LED units 14′A through the third LED units 14′C each have three LED chips. The LED chips are, namely the red chip 141′r, the green chip 141′g, and the blue chip 141′b, respectively. The base 10 further comprises a controller 15. The controller 15 is electrically connected to the circuit board 13 to thereby control the duration of light emission of each of the LED chips of the first LED units 14′A through the third LED units 14′C. Referring to Table 3, the controller 15 has three circuits, namely circuit No. 1b, circuit No. 2b, and circuit No. 3b. In the situation where circuit No. 1b is enabled, the LED chips which light up are as follows: red chip 141′r of the first LED units 14′A, green chip 141′g of the second LED units 14′B, and blue chip 141′b of the third LED units 14′C. In the situation where circuit No. 2b is enabled, the LED chips which light up are as follows: green chip 141′g of the first LED units 14′A, blue chip 141′b of the second LED units 14′B, and red chip 141′r of the third LED units 14′C. In the situation where circuit No. 3b is enabled, the LED chips which light up are as follows: blue chip 141′b of the first LED units 14′A, red chip 141′r of the second LED units 14′B, and green chip 141′g of the third LED units 14′C. Due to the aforesaid design, light variations are achieved.

TABLE 3

| | | second | |
|---|---|---|---|
| circuit | first LED units 14′A | LED units 14′B | third LED units 14′C |
| No. 1b | red chip 141′r | green chip 141′g | blue chip 141′b |
| No. 2b | green chip 141′g | blue chip 141′b | red chip 141′r |
| No. 3b | blue chip 141′b | red chip 141′r | green chip 141′g |

In conclusion, the present invention provides an LED spotlight characterized in that: not only does light emitted therefrom take on a special shape according to the configuration-related relationship between an LED unit and the center of a circuit board, but, with treatment, such as polishing, engravement, or casting, having been performed on the inner wall of the opaque pipe, the emitted light imitates the optical and imaging effects of polar auroras. Furthermore, when equipped with a controller, the LED spotlight is capable of changing the color and shape of the emitted light.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. An LED spotlight, comprising a base and a lampshade, wherein
the base comprises;
a power connecting portion;
a heat dissipating portion connected to the power connecting portion;
a circuit board electrically connected to the power connecting portion, wherein a distance between a center of the circuit board and an edge of the circuit board is defined as a first distance; and
at least an LED unit disposed at the circuit board, wherein a distance between the LED unit and the center of the circuit board is defined as a second distance, the second distance being at least 1/10 of the first distance, and the LED unit has at least an LED chip for emitting a first light and a second light; and
the lampshade comprises:
an opaque pipe having a first end and a second end, the first end having an engagement portion, and the second end being connected to the heat dissipating portion; and
a convex lens disposed at the engagement portion,
wherein the first light passes through the convex lens to form a first light-emitting area, and the second light reflects off an inner wall of the opaque pipe before passing through the convex lens to form a second light-emitting area.

2. The LED spotlight of claim 1, wherein, in a situation where the second distance approximates 1/10 of the first distance, the second light-emitting area is crescent-shaped.

3. The LED spotlight of claim 1, wherein, in a situation where the second distance approximates ½ of the first distance, the second light-emitting area is bar-shaped.

4. The LED spotlight of claim 1, wherein, in a situation where the second distance approximates the first distance, the second light-emitting area resembles two connected crescents in shape, and the crescents are aligned lengthwise.

5. The LED spotlight of claim 1, wherein the inner wall of the opaque pipe is treated by polishing, engravement, or casting.

6. The LED spotlight of claim 5, wherein the inner wall of the opaque pipe is marked with straight lines or sloping lines.

7. The LED spotlight of claim 1, wherein the LED unit and the circuit board have an included angle therebetween, and the first light emitted from the LED chips propagates in a direction away from the center of the circuit board.

8. The LED spotlight of claim 7, wherein the included angle ranges from 10° to 80°.

9. The LED spotlight of claim 1, wherein the LED unit is geometrically shaped.

10. The LED spotlight of claim 9, wherein the LED unit is round or heart-shaped.

11. The LED spotlight of claim 1, wherein the convex lens is of a focal length 1 f, and the convex lens is spaced apart from the LED unit by a distance equal to 0.2 f to 1 f.

12. The LED spotlight of claim 1, wherein the LED chips include yellow chips, white chips, red chips, green chips, or blue chips.

13. The LED spotlight of claim 1, wherein the LED unit has three LED chips, including a red chip, a green chip, and a blue chip.

14. The LED spotlight of claim 1, wherein, in a situation where the base has a plurality of LED units, the base further comprises a controller electrically connected to the circuit board to thereby control duration of light emission of the LED chips of the LED unit.

15. The LED spotlight of claim 1, wherein, in a situation where the LED unit has a plurality of LED chips, the base further comprises a controller electrically connected to the circuit board to thereby control duration of light emission of the LED chips.

16. The LED spotlight of claim 1, wherein the base has five LED units.

17. The LED spotlight of claim 1, wherein the opaque pipe is made of a heat dissipating material.

18. The LED spotlight of claim 17, wherein the opaque pipe is made of a metal or a highly thermally conductive plastic.
